(19) United States
(12) Patent Application Publication
(10) Pub. No.: US 2011/0114479 A1
(43) Pub. Date: May 19, 2011

(54) Composite Material Useful in Electrolytic Aluminum Production Cells

(75) Inventors: Russell Lee Yeckley, Latrobe, PA (US); Robinson Lattimer, Wilton, CT (US); Sean Erin Landwehr, Greensburg, PA (US)

(73) Assignee: Kennametal Inc., Latrobe, PA (US)

(21) Appl. No.: 12/618,403

(22) Filed: Nov. 13, 2009

(51) Int. Cl. C25C 7/00; C04B 35/78

(52) U.S. Cl. 204/242; 204/279; 264/332

(57) ABSTRACT

Composite materials comprising titanium diboride and boron nitride that are used to line electrolytic aluminum production cells are disclosed. The composite materials may be used to line the side walls and/or bottom wall of the cell. The ratio of titanium diboride to boron nitride may be controlled in order to provide the desired level of electrical conductivity depending upon the particular region of the cell in which the liner plate is installed. The titanium diboride/boron nitride composite materials exhibit desirable aluminum wetting behavior, and are capable of withstanding exposure to molten cryolite, molten aluminum and oxygen at elevated temperatures during operation of the electrolytic aluminum production cells.

### FIELD OF THE INVENTION

The present invention relates to composite materials for use in electrolytic aluminum production cells, and more particularly relates to the use of composites comprising titanium diboride and boron nitride in the walls of aluminum production cells.

### BACKGROUND INFORMATION

The materials used in electrolytic aluminum production cells must be thermally stable at high temperatures on the order of 1,000° C., and must be capable of withstanding extremely harsh conditions such as exposure to molten cryolite, molten aluminum, and oxygen at elevated temperatures. Although various types of materials have been used to line the walls of electrolytic aluminum production cells, a need still exists for improved materials capable of withstanding such harsh conditions.

### SUMMARY OF THE INVENTION

The present invention provides composite materials comprising titanium diboride and boron nitride that are used to line electrolytic aluminum production cells. The composite materials may be used to line the side walls and/or bottom wall of the cell. The ratio of titanium diboride to boron nitride may be controlled in order to provide the desired level of electrical conductivity depending upon the particular region of the cell in which the liner plate is installed. The titanium diboride/boron nitride composite materials exhibit desirable aluminum wetting behavior, and are capable of withstanding exposure to molten cryolite, molten aluminum and oxygen at elevated temperatures during operation of the electrolytic aluminum production cells.

An aspect of the present invention is to provide a composite liner plate of an electrolytic aluminum production cell, the composite liner plate comprising TiB₂ and BN.

Another aspect of the present invention is to provide a method of making a composite liner plate for an electrolytic aluminum production cell. The method comprises mixing TiB₂ powder and BN powder, and consolidating the mixture of TiB₂ and BN to form the composite liner plate.

A further aspect of the present invention is to provide an aluminum production cell comprising a bottom wall and a side wall for containing molten cryolyte, wherein at least one of the bottom wall and side wall comprise a composite liner plate comprising TiB₂ and BN.

These and other aspects of the present invention will be more apparent from the following description.

### BRIEF DESCRIPTION OF THE DRAWINGS

FIG. 1 is a partially schematic side sectional view of an electrolytic aluminum production cell including walls made of a titanium diboride/boron nitride composite material in accordance with an embodiment of the present invention.

FIGS. 2-4 are photomicrographs of titanium diboride/boron nitride composite materials having different ratios of TiB₂ to BN in accordance with embodiments of the present invention.

### DETAILED DESCRIPTION OF PREFERRED EMBODIMENT

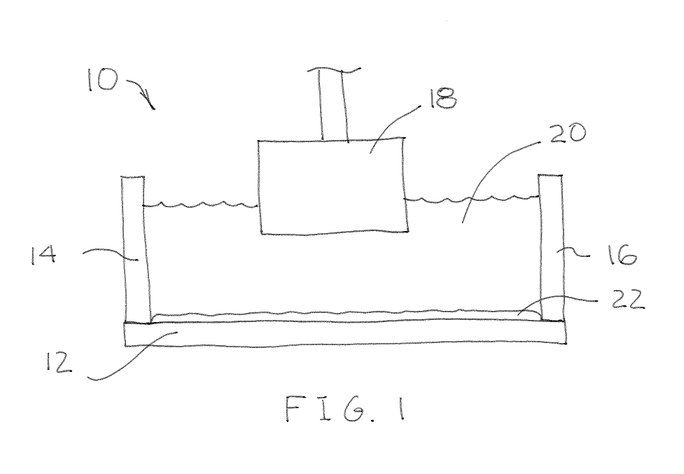

FIG. 1 schematically illustrates an electrolytic aluminum production cell 10 including a bottom wall 12 and side walls 14, 16. An anode 18 extends into the cell 10. The anode 18 may be a carbonaceous consumable anode, or may be a stable inert anode. During the electrolytic aluminum production process, the cell 10 contains molten cryolite 20 comprising alumina in a fluoride salt bath, and current is generated between the anode 18 and the cathode bottom wall 12 of the cell. During the electrolytic reduction process, the alumina in the molten cryolite 20 is converted to aluminum 22, which settles on the bottom wall 12 of the cell. The cell 10 is typically open to the atmosphere, and at least the upper portions of the side walls 14 and 16 are exposed to oxygen in the surrounding air. Each of the bottom wall 12, and side walls 14 and 16, must be thermally stable at the elevated temperatures experienced during the electrolytic process, and must be capable of withstanding exposure to molten cryolite, molten aluminum, and oxygen at such elevated temperatures. In addition, the bottom wall 12, and side walls 14 and 16, must have satisfactory aluminum wetting characteristics and controlled levels of electrical conductivity.

In accordance with the present invention, the bottom wall 12 and/or side walls 14 and 16 of the cell 10 may be made of a composite material comprising titanium diboride and boron nitride. The titanium diboride typically comprises from about 50 to about 99 weight percent of the composite, preferably from about 70 to about 98 weight percent of the composite. The boron nitride typically comprises from about 1 to about 50 weight percent of the composite, preferably from about 2 to about 30 weight percent of the composite. In an embodiment of the invention, the titanium diboride content may range between 75 and 95 percent, and the boron nitride content may range between about 5 and 25 weight percent where good aluminum wetting behavior and resistance to molten cryolite are required. The titanium diboride phase of the composite material typically forms a continuous interconnected skeleton in the material, while the boron nitride phase may be either continuous or discontinuous, depending upon the relative amount of boron nitride that is present in the material.

The bottom wall 12, and side walls 14 and 16, of the cell 10 may be fabricated in the form of plates that are installed in the interior side walls of the cell. The plates may have any suitable thickness.

In accordance with an embodiment of the present invention, the ratio of titanium diboride to boron nitride in the composite material may be controlled in order to provide the desired amount of electrical conductivity, depending upon the particular location in the cell. For example, the boron nitride content may be relatively low in sections where higher electrical conductivity is required. In such high-conductivity regions, the boron nitride content may range from about 1 to about 10 weight percent, typically from about 3 to about 8 weight percent. As a particular example, the boron nitride content may be about 5 weight percent in such regions. In regions where lower electrical conductivity or higher electrical insulating characteristics are required, the boron nitride content of the composite material may be increased to 10 or 20 weight percent, or higher. For example, the boron nitride content may be at least 25 weight percent and up to 50 weight percent or more in such electrical insulating regions.

In accordance with an embodiment of the present invention, a liner plate of the composite material may comprise a graded composition in which the ratio of titanium diboride to boron nitride is varied throughout the plate. For example, for a side wall liner plate, the upper portion of the plate that is exposed to cryolite and oxygen may have a different ratio of titanium diboride to boron nitride than the lower portion of such a side wall liner plate that is positioned adjacent to the bottom wall of the cell. In addition to adjusting the TiB₂:BN ratio along the height of a side wall liner plate, the ratio may be adjusted through the thickness of the plate. For example, the surface of the plate that is exposed to the molten cryolite and aluminum in the cell may have a different ratio of titanium diboride to boron nitride than the interior region of the liner plate.

The present composite materials may be made by any suitable method such as hot pressing a mixture of the titanium diboride and boron nitride powders. The titanium diboride powder typically has an average particle size range of from about 1 to about 50 microns, for example, from about 2 to about 10 microns. The boron nitride powder typically has an average particle size range of from about 1 to about 50 microns, for example, from about 2 to about 10 microns. The powders may be mixed in the desired ratio by any suitable mixing method such as dry blending or ball milling. The resultant powder mixture may be hot pressed at pressures typically ranging from about 20 to about 50 MPa and temperatures typically ranging from about 1,800 to about 2,200° C. The resultant hot pressed powders have high densities, typically above 95 percent, for example, above 98 or 99 percent.

Composite TiB₂-BN plates were made from TiB₂ powders having the specifications set forth in Table 1 below, and BN powders having specifications set forth in Tables 2 and 3 below.

TABLE 1
Specifications for TiB₂

| | Units | Min | Max |
|---|---|---|---|
| Boron Content | weight % | 30.0 | 31.0 |
| Carbon Content | weight % | | 0.09 |
| Calcium Content | weight % | | 0.5 |
| Nitrogen Content | weight % | 0.1 | 0.8 |
| Oxygen Content | weight % | 0.6 | 1.5 |
| d₁₀ | μm | 1.5 | 2.5 |
| d₅₀ | μm | 5.5 | 6.0 |
| d₉₀ | μm | | 13 |

TABLE 2
Specifications for BN Grade A

| | Units | Min | Max |
|---|---|---|---|
| Boron Content | weight % | 42.5 | |
| Carbon Content | weight % | | 0.1 |
| Oxygen Content | weight % | | 1.5 |
| Moisture | weight % | | 0.7 |
| Surface Area | m²/g | 10 | 20 |
| d₅₀ | μm | 4 | 6 |
| d₅₀ | μm | 10 | 14 |
| Tap Density | g/cm³ | 0.17 | 0.28 |

TABLE 3
Specifications for BN Grade B

| | Units | Min | Max |
|---|---|---|---|
| Boron Oxide | weight % | | 0.7 |
| Carbon Content | weight % | | 0.05 |
| Oxygen Content | weight % | | 1.5 |
| Moisture | weight % | | 0.4 |
| Surface Area | m²/g | 10 | 30 |
| d₅₀ | μm | 4.5 | 6.5 |
| d₉₀ | μm | | 13 |
| Tap Density | g/cm³ | 0.25 | 0.5 |

Three different TiB₂:BN weight ratios were mixed with a dry powder blending process. The ratios employed were 95% TiB₂-5% BN, 85% TiB₂-15% BN, and 75% TiB₂-25% BN. Both the first and second grades of BN were employed to make six different compositions. The different ratios and compositions allow tailoring of wettability by molten A1 as well as electrical conductivity in the Hall-Héroult process.

The blended powders were loaded into a graphite die for hot pressing. The hot pressing schedule was as follows, with the maximum temperature being 1,900° C. for 15 and 25% BN, and 2,100° C. for 5% BN: pull vacuum to <100 mtorr; apply 7 MPa of pressure to the compact and heat at 10 C/min to 1,650 C while under vacuum; hold for 1 hr under vacuum while maintaining 7 MPa of pressure; after hold backfill with Ar and heat at 5 C/min to maximum temperature while maintaining 7 MPa of pressure; once maximum temperature is reached hold for 10 min with 7 MPa load; after the hold apply load slowly over 10 min to the maximum pressure of 30 MPa; hold at maximum temperature and 30 MPa until ram travel stops; once ram travel stops allow the furnace to cool but maintain 30 MPa of pressure until 1,300° C. is reached; and once 1,300° C. is reached release pressure and allow to cool to room temperature.

After the materials were hot pressed, their density was measured. Vickers hardness was measured on polished cross-sections of the material and Young's modulus was determined with a time-of-flight calculation using an ultrasonic transducer. Because of the anisotropic nature of BN, Young's modulus was measured both in the directions parallel to hot pressing and perpendicular to hot pressing. The properties of the six different compositions are shown in Table 4.

TABLE 4
Properties of Hot Pressed TiB₂—BN Composites

| | Volume % | Density (g/cm³)/ | Young's Modulus (GPa) | | Vickers Hardness |
|---|---|---|---|---|---|
| Composition | BN | % Theoretical | ⊥ to HP | ∥ to HP | (GPa) |
| 5% BN Grade A | 9.8 | 4.24/98.8 | 465 | 415 | 15.8 |
| 5% BN Grade B | 9.8 | 4.24/98.8 | 460 | 400 | 15.5 |
| 15% BN Grade A | 26.8 | 3.84/98.7 | 330 | 265 | 5.1 |
| 15% BN Grade B | 26.8 | 3.87/99.5 | 310 | 260 | 5.8 |
| 25% BN Grade A | 40.9 | 3.55/99.7 | 220 | 175 | 3.2 |
| 25% BN Grade B | 40.9 | 3.56/100.0 | 205 | 175 | 3.0 |

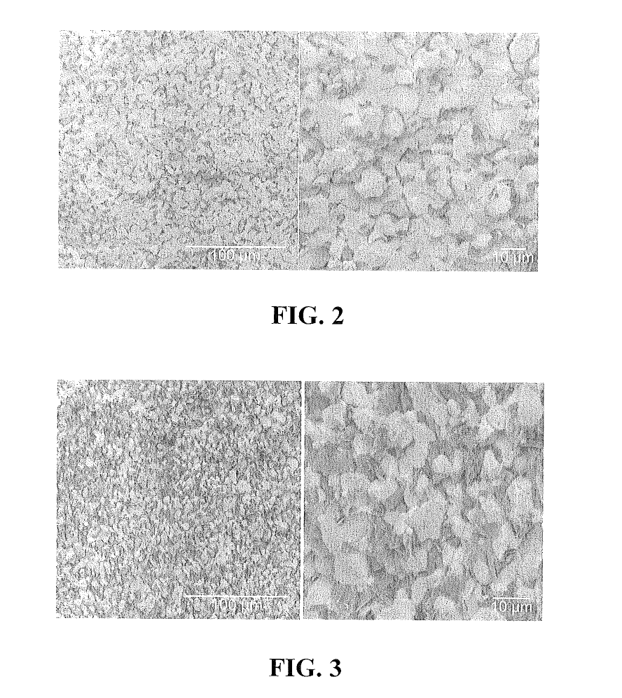

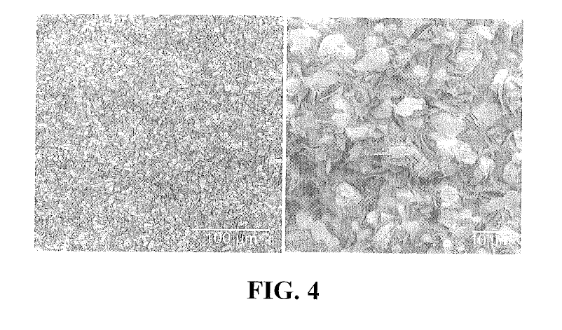

Upon examining the microstructures it was found that there was no discernable difference between the first BN and second BN compositions for each amount of BN. Additionally, no obvious microstructural anisotropy was observed, despite the Young's modulus measurements that suggest otherwise. Microstructures of the 95% TiB₂, 85% TiB₂, and 75% TiB₂ samples at high and low magnification are shown in FIGS. 2, 3 and 4, respectively. In each micrograph, the lighter gray phase is TiB₂ while the darker gray phase is the BN.

Whereas particular embodiments of this invention have been described above for purposes of illustration, it will be evident to those skilled in the art that numerous variations of the details of the present invention may be made without departing from the invention as defined in the appended claims.

1. A composite liner plate of an electrolytic aluminum production cell, the composite liner plate comprising TiB₂ and BN.

2. The composite liner plate of claim 1, wherein the TiB₂ comprises from about 50 to about 99 weight percent of the composite liner plate, and the BN comprises from about 1 to about 50 weight percent of the composite liner plate.

3. The composite liner plate of claim 1, wherein the TiB₂ comprises from about 70 to about 98 weight percent of the composite liner plate, and the BN comprises from about 2 to about 30 weight percent of the composite liner plate.

4. The composite liner plate of claim 1, wherein the TiB₂ comprises from about 75 to about 95 weight percent of the composite liner plate, and the BN comprises from about 5 to about 25 weight percent of the composite liner plate.

5. The composite liner plate of claim 1, wherein the relative amounts of TiB₂ and BN are varied at different locations in the plate.

6. The composite liner plate of claim 5, wherein the ratio of TiB₂ to BN is varied at different locations in a plane of the plate.

7. The composite liner plate of claim 5, wherein the ratio of TiB₂ to BN is varied through a thickness of the plate.

8. The composite liner plate of claim 1, wherein the TiB₂ has an average particle size of from about 1 to about 50 microns, and the BN has an average particle size of from about 1 to about 50 microns.

9. A method of making a composite liner plate for an electrolytic aluminum production cell, the method comprising:
mixing TiB₂ powder and BN powder; and
consolidating the mixture of TiB₂ and BN to form the composite liner plate.

10. The method of claim 9, further comprising washing the BN powder.

11. The method of claim 10, wherein the BN powder is washed before mixing with the TiB₂ powder.

12. The method of claim 9, wherein the mixture of TiB₂ and BN is consolidated by hot pressing.

13. An aluminum production cell comprising a bottom wall and a side wall for containing molten cryolyte, wherein at least one of the bottom wall and side wall comprise a composite liner plate comprising TiB₂ and BN.

14. The aluminum production cell of claim 13, wherein the TiB₂ comprises from about 50 to about 99 weight percent of the composite liner plate, and the BN comprises from about 1 to about 50 weight percent of the composite liner plate.

15. The aluminum production cell of claim 13, wherein the TiB₂ comprises from about 70 to about 98 weight percent of the composite liner plate, and the BN comprises from about 2 to about 30 weight percent of the composite liner plate.

16. The aluminum production cell of claim 13, wherein the TiB₂ comprises from about 75 to about 95 weight percent of the composite liner plate, and the BN comprises from about 5 to about 25 weight percent of the composite liner plate.

17. The aluminum production cell of claim 13, wherein the relative amounts of TiB₂ and BN are varied at different locations in the plate.

18. The aluminum production cell of claim 17, wherein the ratio of TiB₂ to BN is varied at different locations in a plane of the plate.

19. The aluminum production cell of claim 17, wherein the ratio of TiB₂ to BN is varied through a thickness of the plate.

20. The aluminum production cell of claim 13, wherein the TiB₂ has an average particle size of from about 1 to about 50 microns, and the BN has an average particle size of from about 1 to about 50 microns.
